(19) United States
(12) Patent Application Publication
(10) Pub. No.: US 2010/0134679 A1
(43) Pub. Date: Jun. 3, 2010

(54) METHOD AND APPARATUS FOR SYNCHRONIZING A CAMERA FLASH ACCESSORY FOR MOBILE ELECTRONIC DEVICE USING A DISPLAY AND OPTICAL SENSOR

(76) Inventor: Peter Yuanyu Lin, San Gabriel, GA (US)

Correspondence Address: Loza & Loza LLP;Raz Messerian, Esq., 305 North Second Avenue, #127, Upland, CA, 91786-6064, US

(21) Appl. No.: 12/699,744

(22) Filed: Feb. 3, 2010

(51) Int. Cl. H04N 5/222; G03B 15/03

(52) U.S. Cl. 348/371; 396/155; 348/E05.022

(57) ABSTRACT

A system and method for using an optical sensor with the display of a mobile electronic device for providing and synchronizing a high power flash device with the mobile electronic device's integrated camera. The system and method features a flash unit subsystem that comprises an optical sensor, a controller, and a flash device that works in conjunction with a management system installed onto the mobile electronic device. The management system controls whether the flash device turns off or on by causing a select portion of the display of the mobile electronic device to brighten or dim, the change in intensity of which is sensed by the optical sensor. The system is substantially synchronized in that the flash device turns on slightly before the image capture process begins and turns off slightly after the image capture process ends.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

This application generally relates to an accessory flash system for portable electronic devices capable. More specifically, it relates to systems and methods for using an optical sensor with the display of a portable electronic device to provide and synchronize a high power flash device with a camera of the portable electronic device.

2. Prior Art

A multitude of portable electronic devices, such as cellular telephones, PDAs, and laptops have onboard camera systems capable of capturing images and video. However, the camera systems of these portable electronic devices have limited capability to capture images in low light settings because they have low power flash systems, or lack a flash system entirely.

Typically, prior art camera systems of portable electronic devices are equipped with a low power light emitting diode (LED), or other low power light source, to illuminate a target object during the image capture process. However, these low power light sources frequently fail to adequately illuminate the target object sufficiently to acquire a crisp, bright image of the target. Moreover, some low end camera systems do not synchronize the low power light source with the image capture process, and thus the light source stays lit for an unnecessary period of time before and/or after the image capture process has completed.

Portable electronic devices, such as cellular phones, employ such low power light sources because power consumption and battery life for these small portable devices are a major concern. Integrating a high power light source onto a portable electronic device presents significant engineering and design issues that ultimately prove impractical for use with devices whose principal use is not to capture images. For example, a high power LED can consume several watts of power and draw as much as an amp or more of current. Supplying that amount of power and current is not practical for small portable electronic devices whose components typically handle currents on the order of microamperes and milliamperes.

Besides power consumption and preserving battery life, integrating high power light sources onto small electronic portable devices also presents other design challenges. For example, another chief concern for portable electronic devices is size and portability. A high power light source requires dedicated circuitry. A manufacturer may decide that the increase in size of the portable electronic device to accommodate the dedicated circuitry is not justified given that the portable electronic device's primarily use is not flash photography, but instead, for example, telecommunication. Moreover, the small size of the portable electronic device makes dissipating the heat generated by the high power light source problematic. Additionally, interference such as line coupling may be a problem given the close vicinity of other electronic components to the high current circuitry of the high power light source.

There exists a need for a high power flash solution that can provide adequate illumination for image capture by a portable electronic device in low light settings. It is an object of the present application to disclose a high power flash system and method that can be attached and detached to a portable electronic device for flash photography as needed by the user. It is another object of the present application to disclose a high power flash system where image acquisition is synchronized with the flash by means of an optical sensor that is triggered by the portable electronic device's display. It is another object of the present application to provide such a high power flash system that is substantially universal, allowing it to function with existing portable electronic devices without direct electrical connection.

Additional objects, advantages, and novel features will be set forth in the detailed description that follows.

### SUMMARY

The present application provides, among other things, a system and method for providing a camera flash for a mobile electronic device comprising: a flash device operative to illuminate a target; an optical sensor operative to receive a light signal from a display of the mobile electronic device, the optical sensor operative to generate a first signal while receiving the light signal from the display, the optical sensor operative to generate a second signal while not receiving the light signal from the display; and wherein the flash device turns on in response to the first signal and turns off in response to the second signal.

In one embodiment, the flash device is a high power LED. In another embodiment, the camera flash further comprises a controller that is operative to receive the first signal and second signal of the optical sensor, and wherein the controller turns the flash device on in response to the first signal and turns the flash device off in response to the second signal. In yet another embodiment, the camera flash is configured to be removably connected to the mobile electronic device. In yet another embodiment, the light signal is generated by a portion of the display of the mobile electronic device that brightens in response to an initiation of an image capture process.

In another embodiment, the generation of the first signal and second signal is substantially synchronized with an image capture process by a camera of the mobile electronic device. In yet another embodiment, the first signal is generated before the image capture process begins, and the second signal is generated after the image capture process ends. In yet another embodiment, the optical sensor is positioned above the portion of the display of the mobile electronic device that brightens.

The present application also provides a system for substantially synchronizing a flash device with an acquisition of an image of a target by a camera of a mobile electronic device comprising: an optical sensor operative to sense a light signal from a display of the mobile electronic device; generate a first signal when sensing the light signal from the display; generate a second signal when not sensing the light signal from the display; and a flash device operative to turn on and illuminate the target in response to the generation of the first signal; turn off in response to the generation of the second signal; and a management system operative to present to a user on the display an option to initiate the acquisition of the image of the target; instruct the display to generate the light signal, the light signal comprising the brightening of a select portion of the display of the mobile electronic device upon execution of the option to initiate the acquisition of the image of the target, the select portion of the display corresponding to an area of the display where the optical sensor is positioned; commence the acquisition of the image of the target by the camera of the mobile electronic device after the flash device illuminates the target in response to the first signal; and terminate the acquisition of the image of the target by the camera of the mobile electronic device before the flash device turns off in response to the generation of the second signal.

### BRIEF DESCRIPTION OF THE DRAWINGS

FIGS. 1A and 1B show perspective views of an embodiment of the flash unit subsystem.

FIG. 2 shows a functional block diagram of one embodiment of the overall accessory flash system.

FIGS. 3 and 4 show a flow chart of the flash generation and image acquisition process performed by one embodiment of the accessory flash system.

FIG. 5 shows a timing diagram illustrating the substantial synchronization of the flash activation with image capture of the target by means of the display and optical sensor.

### DETAILED DESCRIPTION

Component Overview

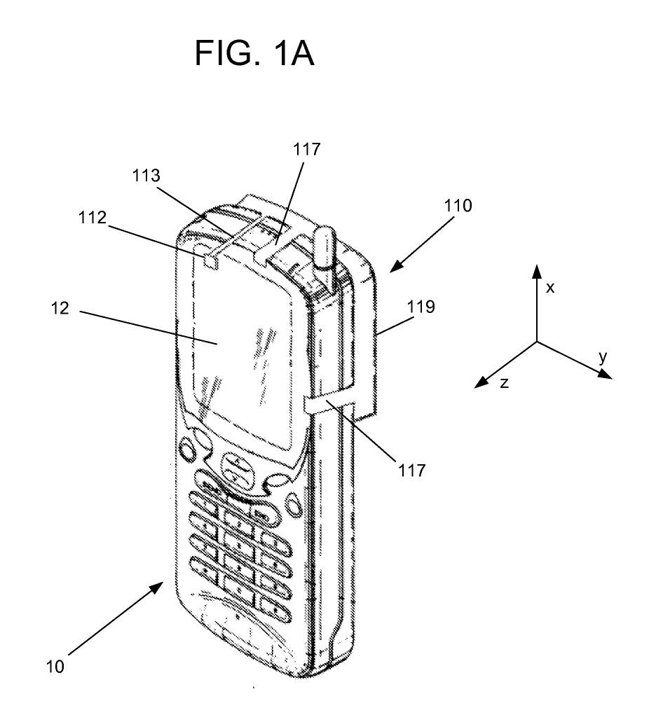

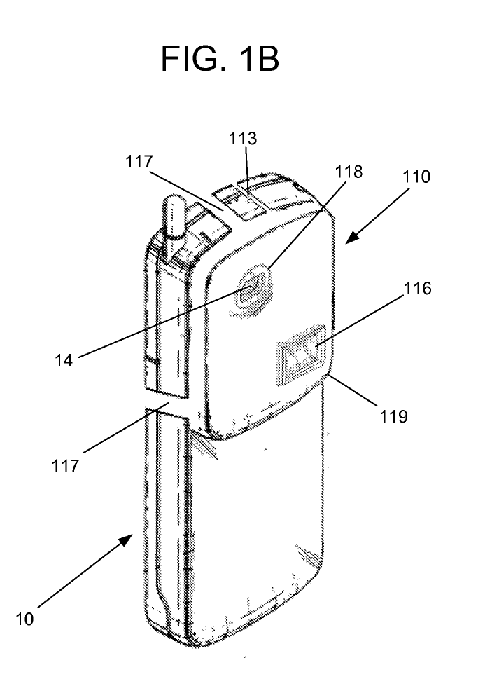

FIGS. 1A and 1B show perspective views of an embodiment of the novel flash unit subsystem 110 mounted onto a portable electronic device 10. The flash unit subsystem 110 features an optical sensor 112, an optical sensor support member 113, a flash device 116, clasps 117, a lens aperture 118, and an outer casing 119. Among other things, the portable electronic device 10 features a display 12, and a camera lens 14 for capturing images. Axes of orientation have also been provided in FIG. 1A. The X-Y plane is substantially oriented so as to be parallel with the plane the display 12 of the mobile electronic device 10 lies in.

The flash unit subsystem 110 can be attached and detached from the mobile electronic device 10, and does not need to be electrically connected to the mobile electronic device 10 through wires to function. In one embodiment, the clasps 117 help attach the flash unit subsystem 110 to the portable electronic device 10. However, other means can be used to keep the flash unit subsystem 110 removably connected to the portable electronic device 10, including, but not limited to, Velcro, latches, screws, magnets, etc. The flash unit subsystem 110 can be designed to attach to and work with any portable electronic apparatus with an integrated display and camera, such as, but not limited to, cellular telephones, PDAs, laptops, digital music players, etc.

The optical sensor 112 can feature any photodiode or phototransistor capable of converting light energy into an electrical signal. In one embodiment, the phototransistor used is a SIEMENS ® LPT-80A phototransistor. In other embodiments, infrared sensing phototransistors with the infrared filter removed can be used, such as a LITE-ON™ LTR-301 phototransistor. As explained in greater detail below, the optical sensor 112 should be positioned directly above a select portion of the display 12 of the portable electronic device 10. Throughout this application, in the context of the optical sensor's 12 position, the terms “directly above,” “above,” “over,” and/or “directly over” the select portion of the display 12 refer to a position located substantially along the Z-axis, shown in FIG. 1A, which is perpendicular to the plane of the select portion of the display 12. In one embodiment, the optical sensor 112 is supported above the select portion of the display 12 through an optical sensor support member 113 as shown in FIGS. 1A and 1B. However, in other embodiments the optical sensor 112 can be positioned above the display 12 by integrating the optical sensor with one of the clasps 117. In yet other embodiments, the outer casing 119 may extend over the top and/or sides of the mobile electronic device 10 creating an overhang above a select portion of the display 12; the optical sensor 112 can be placed anywhere along this overhang as long as it sits directly above the select portion of the display 12.

The flash device 116 is a light source that illuminates the target surface to be photographed. Flash device 116 is preferably any high power LED capable of delivering a short burst of light or staying lit indefinitely (long duration of time), such as a PHILLIPS ® LUXEON ® high power LED. However, in other embodiments the flash device 116 can be any other type of light source that provides adequate illumination of a target for flash photography several meters away, including, but not limited, to Xenon based flash devices, and other high power LEDs.

Lens aperture 118 is an opening through the outer casing 119 that exposes the camera lens 14 belonging to the mobile electronic device 10. This allows the camera lens 14 to have a direct line of sight with a potential target for photography, and not be blocked by the flash unit subsystem 110. In other embodiments, the lens aperture 118 may not be necessary if the outer casing 119 does not cover or otherwise come near the camera lens' 14 line of sight. The outer casing 119 houses the internal contents of the flash unit subsystem 110, which includes, among other things the battery (not shown) and internal circuitry (not shown) of the flash unit subsystem 110.

Flash Generation and Image Acquisition Process

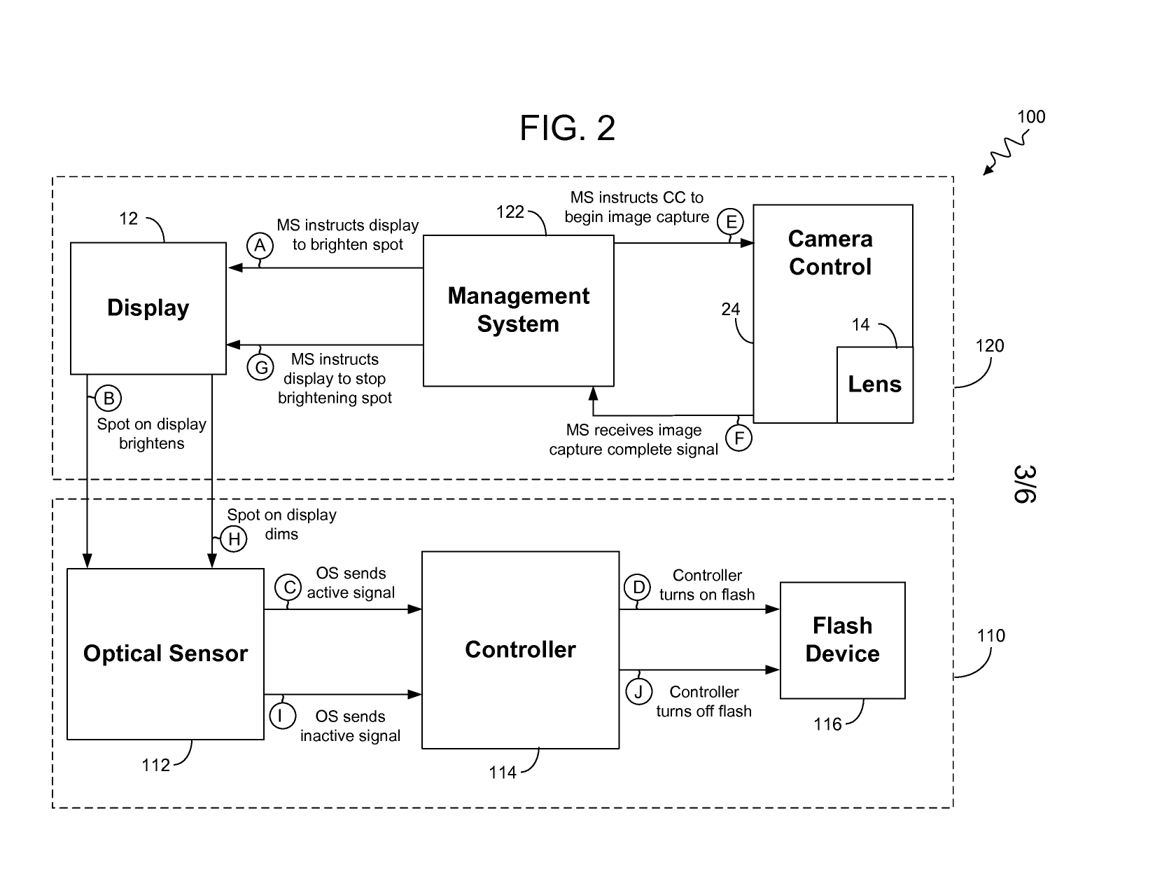

FIG. 2 shows a functional block diagram of one embodiment of the overall accessory flash system 100 comprising the flash unit subsystem 110 and flash control and image capture subsystem 120. The flash unit subsystem 110 comprises the optical sensor 112, a controller 114, and the flash device 116. The flash control and image capture subsystem 120 comprises a management system 122, the display 12, camera control circuitry 24, and the camera lens 14.

In the preferred embodiment, the management system 122 is software that directly or indirectly controls hardware components of the mobile electronic device 10, such as the display 12 and camera lens 14B, through means known in the art, such as object oriented programming. It is also responsible for controlling signals that ultimately enable and disable illumination by the flash device 116, and image acquisition of the target by the camera lens 14. The software files of management system 122 are installed onto and executed by the mobile electronic device 10. The software can be loaded onto the mobile electronic device 10 from a storage device containing the software files, such as but not limited to, a hard disk drive, volatile memory, non-volatile FLASH memory, CD, DVD, etc. Alternatively, the software can be downloaded wirelessly onto the mobile electronic device 10 from the mobile electronic device's service provider, or another third party server.

In the preferred embodiment, the flash unit subsystem 110 is battery powered. The battery (not shown) used to power the flash unit subsystem 110 is powerful enough to manage the current and power requirements of the particular high power flash device 116 used. In one embodiment, the flash unit subsystem 110 is powered by a plurality of AAA or AA size alkaline batteries. In yet other embodiments, the flash unit subsystem 110 is powered by a rechargeable lithium-ion battery, or a nickel-cadmium battery. In yet other embodiments, alternative sources of power, or a combination thereof, can be used in conjunction with batteries, such as solar cells.

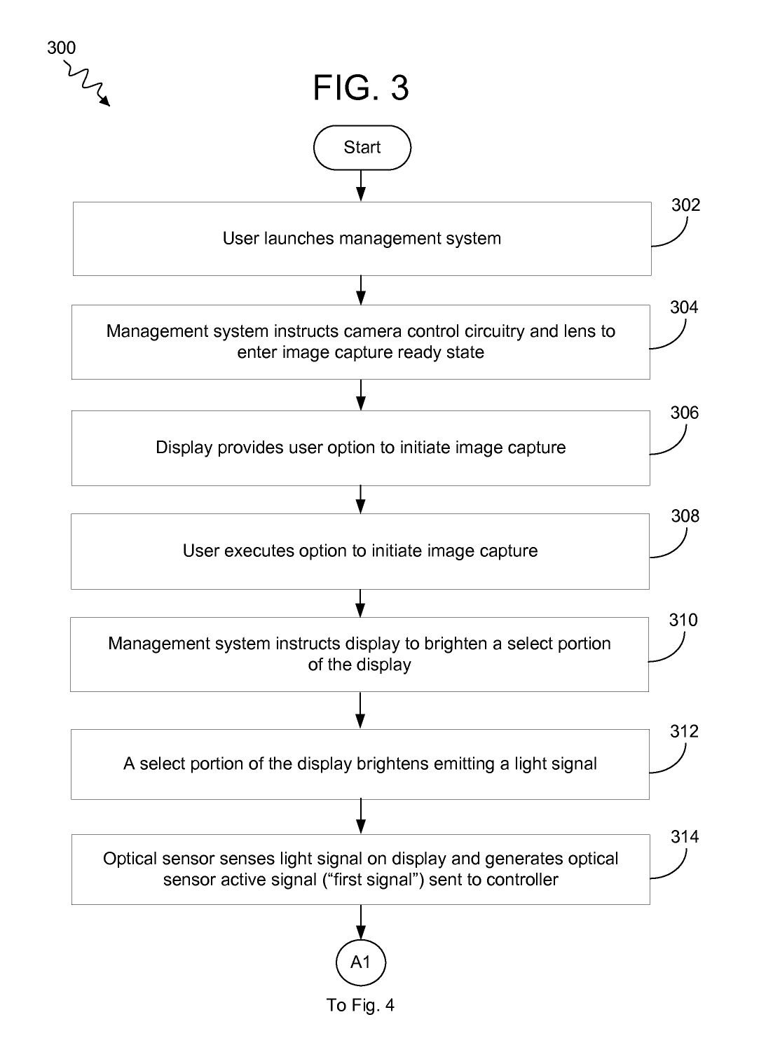

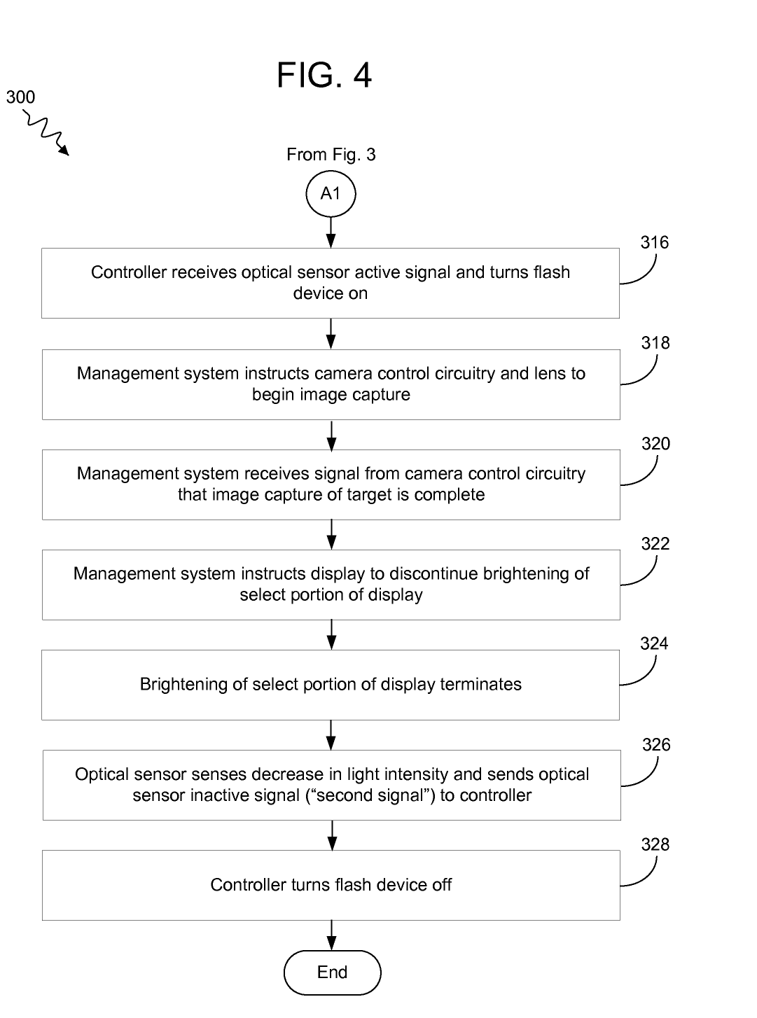

FIGS. 3 and 4 show a flow chart of the flash generation and image acquisition process 300 performed by one embodiment of the accessory flash system 100. For clarity, a portion of the flash generation and image acquisition process 300 is described in conjunction with the block diagram of FIG. 2.

First, a user desiring to take a flash photograph of a target launches the management system 122 software stored on the mobile electronic device 10 (step 302). The management system 122 instructs the camera control circuitry 24 to initialize the lens 14 and to enter an image capture ready state (step 304). For example, the image capture ready state allows the user to preview the target to be photographed on the display 12 as the user aims the lens 14 at the target.

Among other options, the management system 122 then presents the user with an option via the display 12 to initiate image capture (step 306). Assuming the user is ready to take the photograph, the user selects the image capture option (step 308). In response, the management system 122 sends a signal instructing the display 12, or associated display control circuitry (not shown), to brighten a select portion of the display 12 screen (step 310 and step A of FIG. 2).

The specific portion of the display 12 that brightens is based on where the optical sensor 112 is expected to be positioned. For example, for one particular model of a mobile electronic device 10, the optical sensor 112 may be positioned over the upper left-hand corner of the display 12. The management system 122 would then be programmed to cause, e.g., a 10×10 pixel portion of the upper left-hand corner of the display 12 to brighten. These settings may be pre-programmed as a specific release/version of the management system 122 software. The particular release/version of the management system 122 would correspond to a matching hardware configuration of the flash unit subsystem 110 intended for use with a given mobile electronic device 10 design. In other embodiments, the settings may not be fixed according to any particular release but instead may be changed by the user.

After the select portion of the display 12 brightens (step 312 and step B of FIG. 2), the optical sensor 112 senses the increase in light intensity, i.e., the optical sensor 112 receives the light signal sent by the select portion of the display 12, and in response generates an optical sensor active signal (also known as “first signal”) that is sent to the controller 114 (step 314 and step C of FIG. 2). The optical sensor active signal notifies the controller 114 that the flash device 116 should be turned on. In response, the controller 114 turns on the flash device 116 causing the high power flash device 116 to illuminate the target (step 316 and step D of FIG. 2).

After sufficient time has elapsed to allow steps B, C, and D of FIG. 2 to complete, the management system 122 instructs the camera control circuitry 24 and camera lens 14 to begin capturing the target image (step 318 and step E of FIG. 2), since the flash device 116 is now on. The amount of time the management system 122 must wait before performing step E of FIG. 2 depends on, at least, the particular model of flash device 116, controller 114, and optical sensor 112 used, as well as the particular mobile electronic device 10 the accessory flash system 100 is being used with. This is because the propagation delay of these components vary according to the model of component used, and the unique hardware configuration of the mobile electronic device 10. In one embodiment, this amount of time can be fixed according to the particular release/version of the management system 122 that corresponds to a particular hardware configuration. In other embodiments, the amount of time can be set by the user, which is presented to them as a control option.

As will be discussed in greater detail below, the flash device 116 should be on and remain lit during the entire image capture process. For many mobile electronic devices that feature inexpensive digital cameras, the image capture process times can be relatively long—hundreds of milliseconds is not uncommon—and thus the flash device 116 needs to remain lit for at least that duration of time.

After the camera control circuitry 24 and camera lens 14 finish capturing the image of the target, the management system 122 receives a signal from the camera control circuitry 24 informing it that the image capture process is complete (step 320 and step F of FIG. 2). In other embodiments, the management system 122 monitors a signal line for a change that indicates that the image capture process is complete. In other embodiments, the operating system of the mobile electronic device 10 notifies the management system 122 that the thread responsible for image capture is complete. Either way, once the management system 122 is informed that the image capture process is complete it will send a signal to the display 12, or associated display control circuitry (not shown), instructing it to discontinue brightening of the select portion of the display 12 (step 322 and step G of FIG. 2). In response, brightening of the select portion of the display 12 terminates (step 324 and step H of FIG. 2).

As a result, the optical sensor 112 senses the decrease in light intensity (i.e., absence of the light signal), and in response it generates an optical sensor inactive signal (also known as the “second signal”) that is sent to the controller 114 (step 326 and step I of FIG. 2). The optical sensor inactive signal notifies the controller 114 that the flash device 116 should be turned off. In response, the controller 114 turns off the flash device 116, thereby disabling illumination of the target by the high power flash device 116 (step 328 and step J of FIG. 2). Additional flash photographs can be captured by repeating steps 304 through 328 of FIG. 3 and steps A through J of FIG. 2.

Referring to FIGS. 1A and 1B, the optical sensor 112 is ideally positioned directly above the portion of the display 12 that is expected to brighten. The distance separating the optical sensor 112 and the portion of the display 12 that is to brighten is dependent on the type of optical sensor 112 used, it's sensitivity to light, and the particular display 12 of the mobile electronic device 10. In some embodiments the distance between the two may be one or more millimeters. In yet other embodiments, the distance may be less than one millimeter.

When the management system 122 instructs the select portion of the display 12 to brighten, the intensity of light generated by the select portion of the display 12 must exceed a certain threshold in order to properly trigger the optical sensor 112 from its inactive state to its active state. Similarly, when the management system 122 instructs the select portion of the display 12 to dim, the intensity of light generated by the select portion of the display 12 must fall below a certain threshold in order to properly trigger the optical sensor 112 from its active state to its inactive state. These threshold values can be calibrated based on the type of optical sensor 112 employed, the amount of ambient lighting surrounding the optical sensor 112, and the distance between the optical sensor 112 and the display 12.

Synchronization of Flash with Image Capture

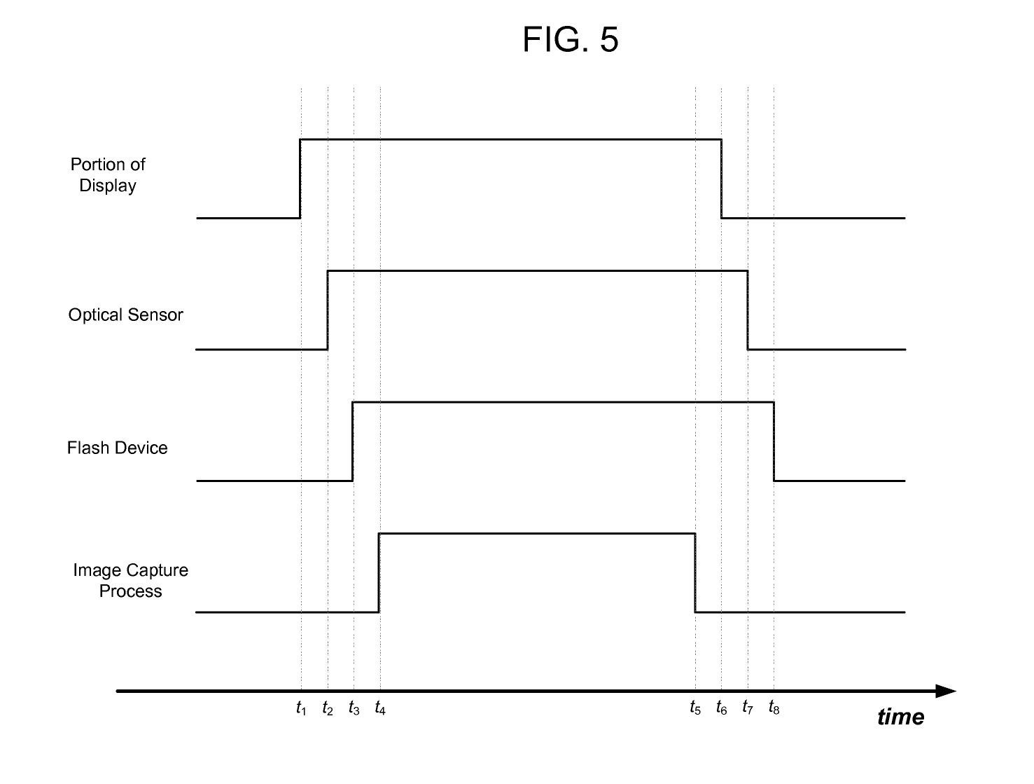

Substantially synchronizing the flash with image acquisition is vital to obtaining a properly illuminated image of the target. Thus, it is necessary that the flash device 116 be on prior to the start of the image capture process carried out by the lens 14, and remain lit until the image capture process ceases. FIG. 5 shows a timing diagram illustrating the substantial synchronization of the flash activation with image capture of the target by means of the display 12 and optical sensor 112. The timing diagram is not to scale or representative of any specific duration of time for any single event or process. Rather, it helps illustrate the order in which the various events and processes take place.

Referring to FIG. 5, at time t₁ the desired specific portion of the display 12 brightens after the management system 122 instructs it to do so. In response, the optical sensor 112 is activated by the brightened portion of the display 12 at time t₂. As a result of the active signal of the optical sensor 112, at time t₃ the flash device 116 turns on. A short time thereafter the image capture process begins at time t₄. After the image capture process by the lens 14 completes at time t₅, the portion of the display 12 dims at time t₆ pursuant to the management system's 122 instructions. In response, at time t₇ the optical sensor 112 is deactivated by the dimmed portion of the display 12. As a result, the flash device turns off at time t₈.

In one embodiment, to promote efficiency and minimize battery consumption it is desirable to keep the flash device 116 lit for an amount of time equal to, or just slightly longer, than the duration of the image capture process. In other words, the duration of time between time t₃ and time t₈ (flash device's 116 ON state) is only just slightly longer than the duration of time between time t₄ and time t₅ (image capture time). This helps keep the flash device 116 on only as long as the image capture process takes to complete, thereby preventing any unnecessary use of battery charge.

Thus, the aforementioned steps of FIGS. 2, 3, and 4, along with the timing diagram of FIG. 5, show how the mobile electronic device's display 12 is strategically used by the management system 122 to substantially synchronize the flash device's 116 activity with image acquisition of the target by the mobile electronic device's camera.

### Other Embodiments

In another embodiment, it may be desirable to keep the flash device 116 lit for a longer period of time before the image capture process starts. For example, a particular mobile electronic device 10 may feature a camera system that automatically adjusts certain settings for the image capture process and/or adjusts the target preview screen based on the amount of lighting of the target. In such cases, turning on the flash device 116 for a longer period of time before image acquisition starts, i.e., extending the duration of time between time t₃ and time t₄ of FIG. 5, allows the camera system to make the necessary adjustments according to the amount of light provided by the flash device 116.

Referring to FIGS. 1A and 1B, the design and shape of the outer casing 119 of the flash unit subsystem 110, along with the location and shape of the optical sensor 112, flash device 116, clasps 117 and lens aperture 118 can vary substantially depending on the specific mobile electronic device 10 the flash unit subsystem 110 is being used with. For example, some mobile electronic devices feature a display that is on the same side as the camera lens. For such mobile electronic devices, the optical sensor 112 would be positioned in a different manner and location but would still be positioned directly over the portion of the display that is anticipated to brighten according to the teachings above. In another embodiment, the outer casing 119 can extend the full length of the mobile electronic device 10.

In one embodiment, the flash unit subsystem 110 features an ON/OFF switch that allows the user to keep the flash device 116 on indefinitely regardless of whether the user intends to take photographs with the camera of the mobile electronic device 10. This flash light mode of operation allows the user to use the flash device 116 like a flash light to illuminate areas of interest. In yet other embodiments, the flash unit subsystem 110 features an energy saving mode that powers down the components of the flash unit subsystem 110 if the optical sensor 112 does not trigger from inactive state to active state for a predetermined period of time. In yet other embodiments, the flash unit subsystem 110 may feature a heat sink to dissipate heat generated by the flash device 116 and associated circuitry.

Referring to FIG. 2, the flash unit subsystem 110 features a controller 114. In some embodiments, the flash unit subsystem 110 does not feature a controller 114 component. Rather, the optical sensor 112 and flash device 116 can be electrically coupled to one another directly or indirectly through the use of other circuitry (resistors, capacitors, transistors, diodes, and/or operational amplifiers) so that the flash device 116 turns on when the optical sensor 112 generates and sends its optical sensor active signal, and the flash device 116 similarly turns off when the optical sensor 112 generates and sends its optical sensor inactive signal. In yet other embodiments, an operational amplifier may be configured between the optical sensor 112 and the controller 114 in order to amplify the optical sensor's 112 signals.

In one embodiment, the management system 122 can be a stand alone program that executes the threads necessary to carry out the functions of process 300. In other embodiments, the management system 122 is configured to interface with existing software of the mobile electronic device 10 that controls image acquisition. In such a configuration, the existing software interacts with the management system 122 to execute the threads responsible for brightening and dimming the portion of the display 12 for flash photography.

The present application provides a high power flash solution for mobile electronic devices equipped with a camera and display without having to compromise the mobile electronic device's portability and size. The high power flash solution presented takes advantage of the display of the mobile electronic device to synchronize a high power flash device with the mobile electronic device's camera. Such a design is practical because it does not require a direct connection to the mobile electronic device with wires, or additional hardware circuitry embedded into the mobile electronic device. The system and methods taught by the present application also avoid the engineering design constraints of embedding a high power flash unit into a mobile electronic device itself. Such design constraints/issues include: line coupling caused by large current signals; providing adequate shielding of such lines and components; and having to provide the high current and power demands of a high power flash device by the mobile electronic device's battery.

Moreover, the flash unit subsystem presented is also better equipped to handle dissipation of the heat generated by the flash device and associated circuitry than a compact mobile electronic device where size and portability of the mobile electronic device are concerns. Furthermore, the system and methods disclosed in the present application provides a high power flash solution for mobile electronic devices that is removably connected to the mobile electronic device. This is practical because it allows the user to detach the flash unit subsystem when flash photography is not needed, which is frequently the case for mobile electronic devices, such as cellular phones, where the primary use is not photography.

The techniques described herein for providing a high power flash solution for mobile electronic devices may be implemented by various means. For example, these techniques may be implemented in hardware, software, or a combination thereof. For a hardware implementation, the processing units used to manage the flash device and camera lens may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

For portions that are implemented by software, such as the management system 122, the techniques may be implemented with modules (e.g., procedures, functions, and so on) that perform the functions described herein. The software codes may be stored in a memory unit of the mobile electronic device 10, e.g., volatile or non-volatile memory, hard disks, etc., and executed by a processor of the mobile electronic device 10. The memory unit may be implemented within the processor or external to the processor, in which case it can be communicatively coupled to the processor via various means as is known in the art.

The previous description of the disclosed embodiments is provided to enable any person skilled in the art to make or use the teachings of the present application. Various modifications to these embodiments will be readily apparent to those skilled in the art, and the generic principles defined herein may be applied to other embodiments without departing from the spirit or scope of the application. Thus, the present application is not intended to be limited to the embodiments shown herein but is to be accorded the widest scope consistent with the principles and novel features disclosed herein.

What is claimed is:

1. A camera flash for a mobile electronic device comprising:
a flash device operative to illuminate a target;
an optical sensor operative to receive a light signal from a display of the mobile electronic device, the optical sensor operative to generate a first signal while receiving the light signal from the display, the optical sensor operative to generate a second signal while not receiving the light signal from the display; and
wherein the flash device turns on in response to the first signal and turns off in response to the second signal.

2. The camera flash of claim 1, wherein the flash device is a high power light emitting diode (LED).

3. The camera flash of claim 1, further comprising a controller operative to receive the first signal and second signal of the optical sensor, wherein the controller turns the flash device on in response to the first signal and turns the flash device off in response to the second signal.

4. The camera flash of claim 1, wherein the camera flash is configured to be removably connected to the mobile electronic device.

5. The camera flash of claim 1, wherein the light signal is generated by a portion of the display of the mobile electronic device that brightens in response to an initiation of an image capture process.

6. The camera flash of claim 1, wherein the generation of the first signal and second signal is substantially synchronized with an image capture process by a camera of the mobile electronic device.

7. The camera flash of claim 6, wherein the first signal is generated before the image capture process begins, and the second signal is generated after the image capture process ends.

8. The camera flash of claim 5, wherein the optical sensor is positioned above the portion of the display of the mobile electronic device that brightens.

9. An apparatus for a mobile electronic device comprising:
a means for generating a flash of light to illuminate a target surface;
a means for sensing light intensity and generating an electrical signal indicative of the intensity of light sensed, said means for sensing light intensity operative to generate a first signal while sensing a light signal from a display of the mobile electronic device, said means for sensing light intensity operative to generate a second signal while not sensing the light signal from the display; and
wherein said means for generating a flash of light turns on to illuminate the target surface in response to the first signal and turns off in response to the second signal.

10. The apparatus of claim 9, wherein the means for generating a flash of light is a high power light emitting diode (LED).

11. The apparatus of claim 10, further comprising a means for controlling the high power LED operative to receive the first signal and second signal, wherein said means for controlling the high power LED turns the high power LED on in response to the first signal and turns the high power LED off in response to the second signal.

12. The apparatus of claim 9, further comprising a means for removably connecting the apparatus to the mobile electronic device.

13. The apparatus of claim 9, wherein the light signal is generated by a portion of the display of the mobile electronic device that brightens in response to an initiation of an image capture process.

14. The apparatus of claim 9, wherein the generation of the first signal and second signal is substantially synchronized with an image capture process by a camera of the mobile electronic device.

15. The apparatus of claim 14, wherein the first signal is generated before the image capture process begins, and the second signal is generated after the image capture process ends.

16. A system for substantially synchronizing a flash device with an image acquisition of a target by a camera of a mobile electronic device comprising:
an optical sensor operative to:
sense a light signal from a display of the mobile electronic device, the light signal comprising a brightening of a select portion of the display of the mobile electronic device, the select portion of the display corresponding to an area of the display where the optical sensor is positioned;
generate a first signal when sensing the light signal from the display;
generate a second signal when not sensing the light signal from the display;
a flash device operative to:
turn on and illuminate the target in response to the generation of the first signal;
turn off in response to the generation of the second signal; and
a management system operative to:
instruct the display to generate the light signal;
commence the image acquisition of the target by the camera of the mobile electronic device after the flash device illuminates the target in response to the first signal; and
terminate the image acquisition of the target by the camera of the mobile electronic device before the flash device turns off in response to the generation of the second signal.

17. The system of claim 16, wherein the management system is further operative to present to a user on the display of the mobile electronic device an option to initiate the image acquisition of the target.
